(19) United States
(12) Patent Application Publication
(10) Pub. No.: US 2026/0313523 A1
(43) Pub. Date: Oct. 8, 2026

(54) TECHNIQUES FOR IMPROVED REGISTRATION AND LOCALIZED SERVICES ACCESS AND FOR A STANDALONE NON-PUBLIC NETWORK (SNPN)

(71) Applicant: SAMSUNG ELECTRONICS CO., LTD., Suwon-si, Gyeonggi-do (KR)

(72) Inventors: Utsav SINHA, Bangalore (IN); Danish Ehsan HASHMI, Bangalore (IN); Lalith KUMAR, Bangalore (IN); Anurag MANDILWAR, Bangalore (IN)

(21) Appl. No.: 19/483,188

(22) PCT Filed: May 13, 2024
(86) PCT No.: PCT/KR2024/006455

§ 371 Date: Nov. 10, 2025

(30) Foreign Application Priority Data
May 12, 2023 (IN) 202341033703
May 13, 2023 (IN) 202341033786
May 13, 2023 (IN) 202341033821
Jun. 28, 2023 (IN) 202341043408
May 2, 2024 (IN) 202341033703

(51) Int. Cl. H04W 48/16; H04W 60/00

(52) U.S. Cl. CPC H04W 48/16; H04W 60/00

(57) ABSTRACT

The disclosure relates to a 5G or 6G communication system for supporting a higher data transmission rate. The present application discloses a method of improved SNPN registration procedure and of dynamically updating a forbidden standalone non-public network (SNPN) list for improved access to localized service. The method comprises performing an SNPN selection procedure for selecting an SNPN and determining, that the UE is unable to select the SNPN for being present in the forbidden SNPN list.

### TECHNICAL FIELD

The present invention generally relates to wireless communication. In particular, the present invention relates to a system and method for improving access to localized services for a Stand-alone Non-Public Network (SNPN). The present invention also relates to a system and method for improving a registration procedure of the SNPN.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A stand-alone non-public network (SNPN) is a private 5G core network that provides restricted access to services. Particularly for SNPNs, 3GPP has introduced the concept of localized services. Localized service is a service which is localized (i.e., provided at specific/limited area) and/or may be bounded in time. The service may be realized via applications (e.g., live, or on-demand audio/video stream, electric game, IMS, etc), or connectivity (e.g., UE to UE, UE to Data Network, etc.). A service provider that provides such service is called a Localized service provider. A Localized service provider is an application provider or network operator who make their services localized and to be offered to end user via a hosting network.

If a mobile station (MS) supports access to a SNPN providing access for localized services in SNPN, the MS shall maintain one list of “temporarily forbidden SNPNs for access for localized services in SNPN” and one list of “permanently forbidden SNPNs for access for localized services in SNPN” per entry of the “list of subscriber data” and per the PLMN subscription. Further, the MS shall use the lists associated with the selected entry of the “list of subscriber data” or the selected PLMN subscription.

The MS shall add an SNPN to the list of “temporarily forbidden SNPNs” (for access for localized services in SNPN, if the SNPN was selected according to SNPN selection criterion for localized services as mentioned in 3GPP TS 23.122 for onboarding services, if the MS is registered for onboarding services in SNPN or performing initial registration for onboarding services in SNPN) which is, if the MS supports access to an SNPN using credentials from a credentials holder, equivalent SNPNs or both associated with the selected entry of the “list of subscriber data” or the selected PLMN subscription and if a message with cause value #74 “Temporarily not authorized for this SNPN” (see 3GPP TS 24.501[64 ]) is received by the MS in response to sending a Location Request (LR) from the SNPN. Further each SNPN is associated with a validity information consisting of time validity information; that define the time periods (defined by start and end times) when access to the SNPN for accessing Localized Services is allowed.

There exists various such scenarios where MS shall add an SNPN to the list of “temporarily forbidden SNPNs” One such scenario is when the SNPN is configured with validity information, and the UE is trying to access the SNPN while validity information is not being met.

These scenarios cause the SNPN to incorrectly continue to stay in the “temporarily forbidden SNPNs for access for localized services in SNPN” or “permanently forbidden SNPNs for access for localized services in SNPN”, and thereby restricting a UE's access to localized services associated with the SNPN.

Thus, there is a need for a system and method for deleting forbidden SNPN from forbidden SNPN for localized services on change of validity information.

Whenever a MS detects that it has entered a new registration area, i.e., when the received registration area identity differs from the one stored in the MS, and the Tracking Area Identity (TAI) or PLMN identity is not contained in any of the lists of “forbidden location areas for roaming”, “forbidden tracking areas for roaming”, “5GS forbidden tracking areas for roaming”, “forbidden location areas for regional provision of service”, “forbidden tracking areas for regional provision of service”, “5GS forbidden tracking areas for regional provision of service”, “forbidden PLMNs for GPRS service” or “forbidden PLMNs”, a Location Request (LR) is made by UE.

Further, 5GS forbidden tracking areas for roaming” or 5GS forbidden tracking areas for regional provision of service, is a list of forbidden tracking areas where the UE is not allowed to operate for normal services (apart from emergency). The MS adds a tracking area to this list when it receives reject causes #12, #15 or #13 or other reason specified in TS 24.501 for example. If the UE is not operating in SNPN access operation mode, the UE shall store a list of “5GS forbidden tracking areas for roaming”, as well as a list of “5GS forbidden tracking areas for regional provision of service”. Otherwise the UE shall store a list of “5GS forbidden tracking areas for roaming” per SNPN; and if the UE supports access to an SNPN using credentials from a credentials holder, equivalent SNPNs or both, per entry of the “list of subscriber data” or, if the UE supports access to an SNPN using credentials from a credentials holder, PLMN subscription and store a list of “5GS forbidden tracking areas for regional provision of service” per SNPN; and if the UE supports access to an SNPN using credentials from a credentials holder, equivalent SNPNs or both, per entry of the “list of subscriber data” or, if the UE supports access to an SNPN using credentials from a credentials holder, PLMN subscription.

Thus, there is a need for a system and method for correcting a forbidden Tracking area removal due to configuration update or any other scenarios by which a tracking area is unnecessarily removed from the above forbidden lists.

The information disclosed in this background of the disclosure section is only for enhancement of understanding of the general background of the invention and should not be taken as an acknowledgment or any form of suggestion that this information forms the prior art already known to a person skilled in the art.

### DISCLOSURE OF INVENTION

### Technical Problem

The principal object of the embodiments herein is to disclose methods and systems for improving access to localized services for a Stand-alone Non-Public Network (SNPN).

### Solution to Problem

This summary is provided to introduce a selection of concepts, in a simplified format, that are further described in the detailed description of the invention. This summary is neither intended to identify key or essential inventive concepts of the invention nor is it intended for determining the scope of the invention.

In one of the non-limiting embodiments of the present disclosure, the present application discloses a method of dynamically updating a forbidden standalone non-public network (SNPN) list for improved access to localized services. The method comprises comprising receiving, by a User Equipment (UE), subscriber data associated with a home network (HN) to which the UE is subscribed, where the subscriber data comprises the forbidden SNPN list having time validity information corresponding to each forbidden SNPN present in the forbidden SNPN list, and where the subscriber data further comprises an indication regarding steering of roaming SNPN selection information for localized services in SNPN (SOR-SNPN-SI-LS). The method further comprises performing an SNPN selection procedure on a plurality of SNPNs capable of being accessed by the UE for selecting at least one SNPN among the plurality of SNPNs and receiving the SOR-SNPN-SI-LS based on the performing of the SNPN selection procedure. The method further comprises upon determining, based on the SNPN selection procedure, that the UE is unable to select the at least one SNPN for being present in the forbidden SNPN list, dynamically updating the forbidden SNPN list by removing an entry corresponding to the at least one SNPN from the forbidden SNPN list, to allow the UE to access the localized services of the at least one SNPN upon detecting the following conditions. The following conditions comprises determining when the time validity information of the at least one SNPN is prior to or matches with current time of the UE; and determining when the time validity information of the least one SNPN changes from not meet condition to meet condition; determining the expiry of a predetermined time-interval being tracked by a timer; and determining when the at least one SNPN is received as part of the SOR-SNPN-SI-LS.

In one of the non-limiting embodiments of the present disclosure, the forbidden SNPN list comprises at least one of: temporarily forbidden SNPNs for access for localized services in SNPN list or a permanently forbidden SNPNs for access for localized services in SNPN list.

In one of the non-limiting embodiments of the present disclosure, the SOR-SNPN-SI-LS is received by the UE based on the indication.

In one of the non-limiting embodiments of the present disclosure, the method comprises updating the at least one of the temporarily forbidden SNPN list or the permanently forbidden SNPN list by adding an SNPN of the plurality of SNPNs when a registration request made by the UE to the SNPN is rejected by the SNPN due to one or more causes provided under 5G Mobility Management (5GMM).

In one of the non-limiting embodiments of the present disclosure, forbidden SNPN list further comprises an SNPN identity and a location validity information corresponding to each forbidden SNPN present in the forbidden SNPN list.

In one of the non-limiting embodiments of the present disclosure, the time validity information comprises one or more time periods in which access to the corresponding SNPN for accessing corresponding localized services is allowed.

In one of the non-limiting embodiments of the present disclosure, after removing the entry corresponding to the at least one SNPN from the forbidden SNPN list, the method further comprising registering the at least one SNPN for allowing the UE to access the localized services in SNPN associated with the at least one SNPN.

In one of the non-limiting embodiments of the present disclosure, the present application discloses a user equipment (UE) for improved access to localized services, comprising a memory; and a processor coupled to the memory. The processor is configured to receive subscriber data associated with a home network (HN) to which the UE is subscribed, where the subscriber data comprises the forbidden standalone non-public network (SNPN) list having time validity information against each forbidden SNPN present in the forbidden SNPN list, where the subscriber data comprises an indication regarding steering of roaming SNPN selection information for localized services in SNPN (SOR-SNPN-SI-LS). Further, the processor is configured to perform an SNPN selection procedure on a plurality of SNPNs capable of being accessed by the UE for selecting at least one SNPN among the plurality of SNPNs. Further, the processor is configured to receive the SOR-SNPN-SI-LS based on the performing of the SNPN selection procedure. Further, the process is configured to dynamically update the forbidden SNPN list by removing an entry corresponding to the at least one SNPN from the forbidden SNPN list, to allow the UE to access the localized services of the at least one SNPN upon determining, based on the SNPN selection procedure, that the UE is unable to select the at least one SNPN for being present in the forbidden SNPN list and detecting one of the following conditions. The conditions are determining when the time validity information of the at least one SNPN is prior to or matches with current time of the UE; when the time validity information of the least one SNPN changes from not meet condition to meet condition; an expiry of a predetermined time-interval being tracked by a timer; and when the at least one SNPN is received as part of the SOR-SNPN-SI-LS.

In one of the non-limiting embodiments of the present disclosure, the forbidden SNPN list comprises at least one of: temporarily forbidden SNPNs for access for localized services in SNPN list or a permanently forbidden SNPNs for access for localized services in SNPN list.

In one of the non-limiting embodiments of the present disclosure, the SOR-SNPN-SI-LS is received by the UE based on the indication.

In one of the non-limiting embodiments of the present disclosure, the processor is further configured to update the at least one of the temporarily forbidden SNPN list or the permanently forbidden SNPN list by adding an SNPN of the plurality of SNPNs when a registration request made by the UE to the SNPN is rejected by the SNPN due to one or more causes provided under 5G Mobility Management (5GMM).

In one of the non-limiting embodiments of the present disclosure, the forbidden SNPN list further comprises an SNPN identity and a location validity information corresponding to each forbidden SNPN present in the forbidden SNPN list.

In one of the non-limiting embodiments of the present disclosure, the time validity information comprises one or more time periods in which access to the corresponding SNPN for accessing corresponding localized services is allowed.

In one of the non-limiting embodiments of the present disclosure, after removing the entry corresponding to the at least one SNPN from the forbidden SNPN list, the processor is further configured to register the at least one SNPN with the HN for allowing the UE to access the localized services associated with the at least one SNPN.

In one of the non-limiting embodiments of the present disclosure, the present application discloses a method of improving a standalone non-public network (SNPN) registration procedure by dynamically updating a forbidden tracking area list. The method comprises in response to performing an SNPN registration procedure by a User Equipment (UE) for registering to an SNPN, receiving the forbidden tracking area list having information pertaining to a plurality of forbidden tracking areas for registration. The method further comprises upon determining a change of a forbidden tracking area present in the forbidden tracking area list into an allowed tracking area, dynamically updating the forbidden tracking area list by removing entry of the allowed tracking area and corresponding SNPN from the forbidden tracking area list, for improving the SNPN registration procedure.

In one of the non-limiting embodiments of the present disclosure, a forbidden tracking area list comprises at least one of: 5GS forbidden tracking areas for roaming list or a 5GS forbidden tracking areas for regional provision of service list.

In one of the non-limiting embodiments of the present disclosure, the present application discloses when the UE operates in an SNPN access operation mode, the dynamically updating of the forbidden tracking area list comprises removing the entry corresponding to the allowed tracking area and corresponding SNPN from the 5GS forbidden tracking areas for roaming list and the 5GS forbidden tracking areas for regional provision of service list.

In one of the non-limiting embodiments of the present disclosure, the present application discloses a user equipment (UE) for improving a standalone non-public network (SNPN) registration procedure, comprising a memory; and a processor coupled to the memory. The processor is configured to in response to performing an SNPN registration procedure by the UE for registering to an SNPN, receive a forbidden tracking area list having information pertaining to one or more forbidden tracking areas for registration; and The method further comprises dynamically update the forbidden tracking area list by removing entry corresponding to the allowed tracking area and corresponding SNPN, from the forbidden tracking area list, for improving the SNPN registration procedure, upon determining a change of a forbidden tracking area present in the forbidden tracking area list into an allowed tracking area.

In one of the non-limiting embodiments of the present disclosure, the forbidden tracking area list comprises at least one of: 5GS forbidden tracking areas for roaming list or a 5GS forbidden tracking areas for regional provision of service list.

In one of the non-limiting embodiments of the present disclosure, when the UE operates in an SNPN access operation mode, to dynamically update the forbidden tracking area list, the processor is further configured to remove entry corresponding to the allowed tracking area and corresponding SNPN from the 5GS forbidden tracking areas for roaming list and the 5GS forbidden tracking areas for regional provision of service list.

### Advantageous Effects of Invention

According to an embodiment of present disclosure, methods and systems for improving access to localized services for a Stand-alone Non-Public Network (SNPN) are provided.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates an environment for improved registration and improved localized service access for one or more standalone non-public networks (SNPNs), in accordance with some embodiments of the present disclosure;

FIG. 2 illustrates a detailed diagram of the UE that is configured to provide improved registration and improved localized service access to a standalone non-public network (SNPN), in accordance with some embodiments of the present disclosure;

FIG. 3 shows a flowchart illustrating an example method for improving an SNPN registration procedure by dynamically updating a forbidden tracking area list, in accordance with some embodiments of the present disclosure.

FIG. 4 shows a flowchart illustrating an example method for deleting forbidden SNPN from “permanently forbidden SNPNs for access for localized services in SNPN” or “temporarily forbidden SNPNs for access for localized services in SNPN” lists, in accordance with some embodiments of the present disclosure.

FIG. 5 shows a flow diagram illustrating a scenario, which shows the handling of forbidden SNPNs, on detecting a change in the validity information, according to embodiments as disclosed herein;

FIG. 6 shows a flow diagram illustrating a scenario, which shows the handling of forbidden SNPNs, on detecting a change in the validity information, where a new 5GMM cause is used by the home network to reject the UE when the UE accesses an SNPN, according to embodiments as disclosed herein;

FIG. 7 shows a flow diagram illustrating a scenario, which shows the handling of forbidden SNPNs, on detecting a change in the validity information and when utilizing an implementation specific timer for a SNPN in the network, according to embodiments as disclosed herein; and

FIG. 8 shows a flow diagram illustrating another exemplary scenario, which shows the handling of forbidden SNPNs, on detecting a change in the validity information and when utilizing specific timers for a SNPN in the network, according to embodiments as disclosed herein; and

FIG. 9 shows a flow diagram illustrating a scenario, handling the deletion of forbidden SNPN from “5GS forbidden tracking areas for roaming” or “5GS forbidden tracking areas for regional provision of service” lists, accordingly to embodiments as disclosed herein.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment”, and similar language throughout this specification may, but do not necessarily, all refer to the same embodiment.

The terms like “mobile equipment ME” and “user equipment UE” and “mobile station MS” may be used interchangeably throughout the description.

Embodiments of the present invention will be described below in detail with reference to the accompanying drawings.

As mentioned in the background section, SNPN refers to a Non-Public Network (NPN) that is operated by an NPN operator. The 3GPP specifications define two access operation modes for a UE. The UE can operate in SNPN access operation mode or out of the SNPN access operation mode. The UE capable of operating in the SNPN access operation mode camps onto a SNPN and receives various services provided by a Non-Public Network (NPN) operator via the SNPN. If a UE supports access to an Stand-alone Non-Public Network (SNPN) providing access for localized services in SNPN, the UE shall maintain one list of “temporarily forbidden SNPNs for access for localized services in SNPN” and one list of “permanently forbidden SNPNs for access for localized services in SNPN” per entry of the “list of subscriber data” and per the PLMN subscription, the UE shall use the lists associated with the selected entry of the “list of subscriber data” or the selected PLMN subscription.

Further 3GPP TS 24.501 describes the lists: “Fifth Generation System (5GS) forbidden tracking areas for roaming” or “5GS forbidden tracking areas for regional provision of service” that represent a list of forbidden tracking areas where a UE is not allowed to operate for normal services (apart from emergency).

The UE stores the list of “5GS forbidden tracking areas for roaming” per SNPN. If the UE supports access to an SNPN using credentials from a credentials holder, equivalent SNPNs or both, then UE stores the list of “5GS forbidden tracking areas for roaming” per entry of the “list of subscriber data”. The UE also stores the list of “5GS forbidden tracking areas for roaming”, if the UE supports access to an SNPN using credentials from a credentials holder, Public Land Mobile Network (PLMN) subscription.

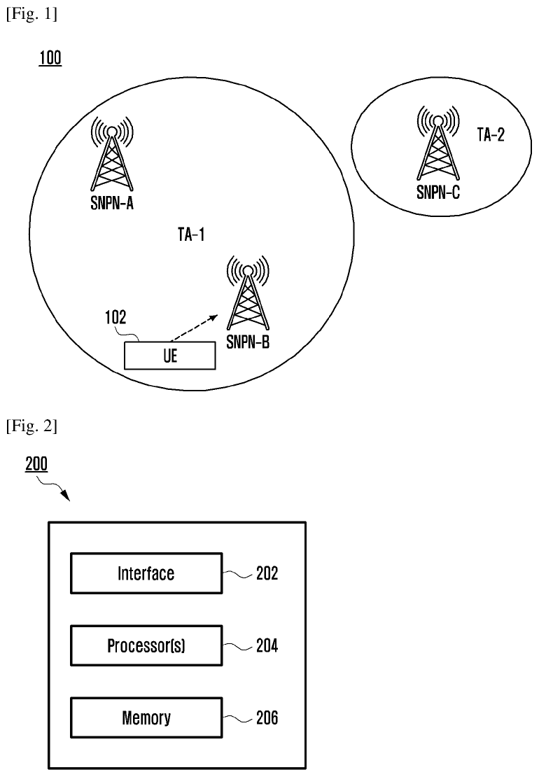

FIG. 1 illustrates an environment for improved registration and improved localized service access for one or more standalone non-public networks (SNPNs), in accordance with some embodiments of the present disclosure. The environment 100 comprises a UE 102 and one or more SNPNs: SNPN-A, SNPN-B, SNPN-C. Each SNPN of the one or more SNPNs may be associated with a tracking area TA. As illustrated in the FIG. 1, SNPN-A and SNPN-B is part of a common tracking area TA-1, while SNPN-C is part tracking area TA-2. The UE 102 may be any device configured to communicate in a wireless network in a Standalone Non-Public Network (SNPN) access mode. Examples of the UE 102 include, but not limited to, mobile phones, smartphones, laptops, wearables, and the like.

As shown in FIG. 1, the UE 102 is capable of operating in a SNPN access operation mode camps onto a SNPN-A and receives various services provided by the network operator. The number of SNPNs shown in FIG. 1 are shown for explanation purposes only.

When registering to an SNPN-A, the UE 102 shall add an SNPN to the list of “temporarily forbidden SNPNs” (for access for localized services in SNPN, if the SNPN was selected according to SNPN selection criterion for localized services as mentioned in 3GPP TS 23.122, i.e., for onboarding services, if the UE 102 is registered for onboarding services in SNPN or performing initial registration for onboarding services in SNPN) which is, if the UE 102 supports access to an SNPN using credentials from a credentials holder, equivalent SNPNs or both associated with the selected entry of the “list of subscriber data” or the selected PLMN subscription, if a message with cause value #74 “Temporarily not authorized for this SNPN” (as mentioned in 3GPP TS 24.501) is received by the UE 102 in response to a Location request (LR) received from the SNPN.

In addition, if: the message is integrity-protected; or the message is not integrity-protected, and the value of the SNPN-specific attempt counter for that SNPN is equal to the UE 102 implementation specific maximum value (as defined in 3GPP TS 24.501), then the UE 102 shall start an UE implementation specific timer not shorter than 60 minutes.

In another embodiment, if the UE 102 supports access to an SNPN providing access for localized services in SNPN, the SNPN selection parameters for access for localized services in SNPN, may consist of firstly a “credentials holder controlled prioritized list of preferred SNPNs for access for localized services in SNPN”, where each entry contains an SNPN identity and a validity information consisting of time validity information, and secondly a “credentials holder controlled prioritized list of preferred GINs for access for localized services in SNPN”, where each entry contains a GIN and a validity information consisting of time validity information.

Further, the UE 102 supporting access to the SNPN that provides access for localized services may provision following information for SNPN selection (if the access for localized services in SNPN has been enabled) the information comprising firstly a credentials holder controlled prioritized list of preferred SNPNs for access for localized services in SNPN, where each entry contains an SNPN identity and a validity information consisting of time validity information and secondly a credentials holder controlled prioritized list of preferred GINs for access for localized services in SNPN, where each entry contains a GIN and a validity information consisting of time validity information, or both of the above information.

Here, the validity information consists of a time validity information, i.e., time periods (defined by start and end times) when access to the SNPN for accessing Localized Services is allowed, optionally Location validity information i.e. location in terms of Geolocation or Tracking area where accessing Localized Services is allowed; and/or Location assistance validity information consisting of: Geolocation information, and/or, Tracking Area information of serving networks, i.e., lists of TACs per PLMN ID or per PLMN ID and NID.

In the present disclosure, the UE 102 is configured to provide improved access to localized services in SNPN.

The plurality of forbidden lists of the SNPN access operation mode may comprise “permanently forbidden SNPNs” list, “temporarily forbidden SNPNs” list managed per access type independently, “permanently forbidden SNPNs” list for network onboarding services, and “temporarily forbidden SNPNs” list for network onboarding services. An SNPN may be added to a forbidden list, when the UE 102 receives a registration reject, a service reject, or a network initiated de-registration request, with cause value #74 (Temporarily not authorized for this SNPN) or #75 (Permanently not authorized for this SNPN). When the SNPN is in the plurality of forbidden lists, the UE 102 cannot select the SNPN for normal services.

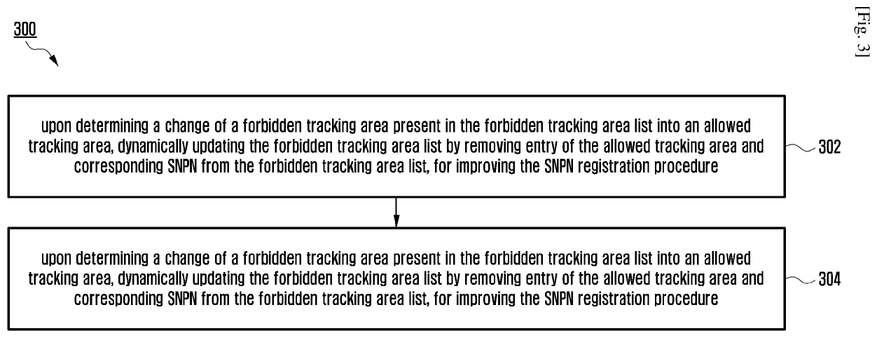

FIG. 2 illustrates a detailed diagram of the UE 102 that is configured to provide improved registration and improved localized service access to a standalone non-public network (SNPN), in accordance with some embodiments of the present disclosure. In particular, FIG. 2 illustrates a detailed diagram 200 of the UE 102, including a processor 204, Input/Output (I/O) interface 202, and a memory 206. In some embodiments, the memory 206 may be communicatively coupled to the processor 204. The memory 206 stores instructions executable by the processor 204. The processor 204 may comprise at least one data processor for executing program components for executing user or system-generated requests. The memory 206 may be communicatively coupled to the processor 204. The memory 206 stores instructions, executable by the processor 204, which, on execution, may cause the processor 204 to manage the registration procedure and manage access to localized services.

The processor 204 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. Further, the I/O interface 202 is coupled with the processor 204 through which an input signal or/and an output signal is communicated.

In one of the non-limiting embodiments of the present disclosure the UE is configured for improving a standalone non-public network (SNPN) registration procedure. The processor 204 may be configured to receive a forbidden tracking area list having information pertaining to one or more forbidden tracking areas for registration, in response to performing an SNPN registration procedure by the UE 102 for registering to an SNPN. The processor 204 may be further configured to dynamically update the forbidden tracking area list by removing entry corresponding to the allowed tracking area and corresponding SNPN, from the forbidden tracking area list, for improving the SNPN registration procedure, upon determining a change of a forbidden tracking area present in the forbidden tracking area list into an allowed tracking area.

In the present disclosure, the processor may be configured to receive subscriber data associated with a home network (HN) to which the UE 102 is subscribed. The subscriber data comprises the forbidden standalone non-public network (SNPN) list having time validity information against each forbidden SNPN present in the forbidden SNPN list. The subscriber data may comprise an indication regarding steering of roaming SNPN selection information for localized services in SNPN (SOR-SNPN-SI-LS). Further, the processor 204 may be configured to perform an SNPN selection procedure on a plurality of SNPNs capable of being accessed by the UE for selecting at least one SNPN among the plurality of SNPNs. Further, the processor may be configured to receive the SOR-SNPN-SI-LS based on the performing of the SNPN selection procedure. Further, the processor 204 may be configured to dynamically update the forbidden SNPN list by removing an entry corresponding to the at least one SNPN from the forbidden SNPN list, to allow the UE to access the localized services of the at least one SNPN upon determining, based on the SNPN selection procedure, that the UE is unable to select the at least one SNPN for being present in the forbidden SNPN list and detecting one of the following conditions. The conditions are determining when the time validity information of the at least one SNPN is prior to or matches with current time of the UE; when the time validity information of the least one SNPN changes from not meet condition to meet condition; an expiry of a predetermined time-interval being tracked by a timer; and when the at least one SNPN is received as part of the SOR-SNPN-SI-LS.

The memory 206 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted that the memory is non-movable. In some examples, the memory can be configured to store larger amounts of information. In certain examples, a non-transitory storage medium may store data that can, over time, change (e.g., in Random Access Memory (RAM) or cache).

The processor 204 may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

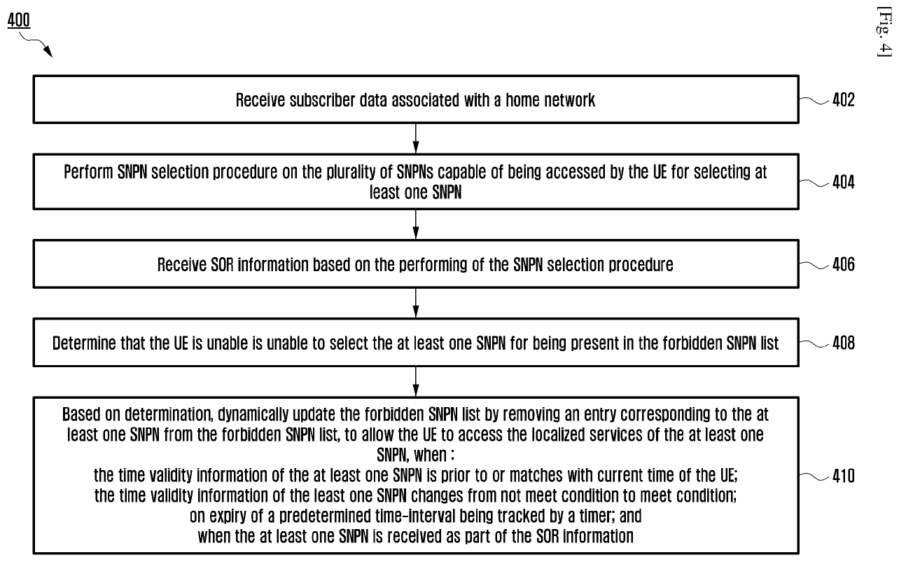

FIG. 3 shows a flowchart illustrating an example method for improving an SNPN registration procedure by dynamically updating a forbidden tracking area list, in accordance with some embodiments of the present disclosure.

The UE may store the list of “5GS forbidden tracking areas for regional provision of service” per SNPN. If the UE supports access to an SNPN using credentials from a credentials holder, equivalent SNPNs or both, then UE may store the list of “5GS forbidden tracking areas for regional provision of service” per entry of the “list of subscriber data”. The UE also stores the list of “5GS forbidden tracking areas for regional provision of service”, if the UE supports access to an SNPN using credentials from a credentials holder, Public Land Mobile Network (PLMN) subscription;

Within the 5GS, these lists are managed independently per access type, i.e., 3GPP access or wireline access. These lists are erased when:
a) the UE is switched off, the Universal Integrated Circuit Card (UICC) containing the Universal Subscriber Identity Module (USIM) is removed, an entry of the “list of subscriber data” with the subscribed SNPN identity identifying the current SNPN is updated or, if the UE supports access to an SNPN using credentials from a credentials holder, the entry of the “list of subscriber data” associated with the lists is updated; and
b) periodically (with a period in the range 12 to 24 hours).

In the present disclosure, a configuration update command is sent by a network to the UE in a connected mode for a configuration update procedure. A configuration update procedure allows an Access Mobility Management Function (AMF) to update the UE configuration for access and mobility management-related parameters decided and provided by the AMF by providing new parameter information within the command. The configuration update procedure is also provided to request the UE to perform a registration procedure for mobility and periodic registration update towards the network to update access and mobility management-related parameters decided and provided by the AMF. The configuration update procedure is also provided to deliver an Unmanned Aerial Vehicle (UAV) authorization information to the UE. The configuration update procedure is also provided to update a Paging Early Indication with Paging Subgrouping (PEIPS) assistance information in the UE.

In one of the embodiments of the present disclosure, the UE may support equivalent SNPNs. If the UE supports equivalent SNPNs, the UE shall store up to one list of equivalent SNPNs per entry of “list of subscriber data”. The UE may also store up to one list of equivalent SNPNs per the PLMN subscription if the UE supports access to an SNPN using credentials from a credentials holder. SNPNs in the list of equivalent SNPNs associated with the selected entry of “list of subscriber data” or the selected PLMN subscription shall be regarded by the UE as equivalent to each other for SNPN selection, cell selection and cell re-selection.

When the UE receives reject causes #12, #15 or #13 or other reason specified in TS 24.501, the UE adds a tracking area (TA) to the “5GS forbidden tracking areas for regional provision of service” or “5GS forbidden tracking areas for regional provision of service”.

In the conventional method, the tracking area is removed from the list of “5GS forbidden tracking areas for roaming”, as well as the list of “5GS forbidden tracking areas for regional provision of service”, if the UE receives the tracking area in the Tracking Area Identity List (TAI list) or the Service area list of “allowed tracking areas” in REGISTRATION ACCEPT message or a CONFIGURATION UPDATE COMMAND message. There exists other relevant Non Access Stratum (NAS) procedures for which the tracking area may be removed from the above forbidden lists.

The present disclosure describes various embodiments for handling the deletion of a Forbidden Tracking Area Identity (FTAI) of an SNPN from these lists.

For instance, considering the scenario, when a UE is registered in SNPN-A and under a Tracking Area Code (TAC-1) or on the Tracking Area Identity-1 (TAI-1). Due to prevalent reject cause code received by a UE, these lists of “5GS forbidden tracking areas for roaming” or “5GS forbidden tracking areas for regional provision of service” may contains: i) SNPN-A (PLMN-A code+NID-A), TAI-2 (PLMN-A+TAC-2), i.e. say PLMN-A code+NID-A+TAC-2. ii) SNPN-B (PLMN-A code+NID-B), TAI-2 (PLMNA+TAC-2) i.e. say PLMN-A code+NID-B+TAC.

Here, SNPN ID may be a combination of PLMN ID and NID. The TAI may be a combination of TAC and PLMN ID. Here, NID is the network identifier associated with an SNPN.

The UE may then receive a CONFIGURATION UDPATE COMMAND indicating or REGISTRATION ACCEPT with TAI-2 for SNPN-A in the tracking area in the TAI list or the Service area list of “allowed tracking areas”. As per the existing technique, UE removes the tracking area for both entries in the lists. In the conventional method causes the forbidden TAI to be removed from the other SNPN as well. For example, in the above example the UE removes the TAI-2 causing incorrect removal of PLMN-A TAC-2 from the “5GS forbidden tracking areas for roaming” or “5GS forbidden tracking areas for regional provision of service” for each SNPN and list of subscriber data. Therefore, tracking area corresponding to TAI-2 will be removed for both entries corresponding to SNPN-A and SNPN-B of the lists. This leads to UE exhibiting incorrect behavior particularly when considering. SNPN-B, and thereafter incorrectly camping in SNPN-B TAC-2, which was supposed to be still in the “5GS forbidden tracking areas for roaming” or “5GS forbidden tracking areas for regional provision of service”. Here, when the UE sends a registration request to the SNPN-B, TAC-2, will subsequently get rejected by the home network.

The present disclosure provides techniques where the UE is configured to restrict unnecessary removal of forbidden TAs. When the UE receives the configuration update command at the PLMN-A code and the TAC-2 is part of allowed tracking area list, the UE removes the PLMN-A code and the TAC-2 from the forbidden lists only for the SNPN-A. This does not impact the entry corresponding to SNPN-B comprising PLMN-A code+TAC-2.

On removing the PLMN-A code and TAC-2 from the lists only for current camped SNPN, i.e. for SNPN-A for the selected entry of the “list of subscriber data” or PLMN subscription, the UE does not re-select SNPN-B, TAC-2, when considering selection of SNPN-B.

As illustrated in FIG. 3, the method 300 may comprise one or more steps. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

The method 300 may comprise, at step 302, receiving the forbidden tracking area list having information pertaining to a plurality of forbidden tracking areas for registration, in response to performing an SNPN registration procedure by a User Equipment (UE) for registering to an SNPN.

The method may further comprise, at step 304, dynamically updating the forbidden tracking area list by removing entry of the allowed tracking area and corresponding SNPN from the forbidden tracking area list, for improving the SNPN registration procedure, upon determining a change of a forbidden tracking area present in the forbidden tracking area list into an allowed tracking area.

In one of the non-limiting embodiments of the present disclosure, a forbidden tracking area list comprises at least one of: 5GS forbidden tracking areas for roaming list or a 5GS forbidden tracking areas for regional provision of service list.

In one of the non-limiting embodiments of the present disclosure, when the UE operates in an SNPN access operation mode, the dynamically updating of the forbidden tracking area list comprises removing the entry corresponding to the allowed tracking area and corresponding SNPN from the 5GS forbidden tracking areas for roaming list and the 5GS forbidden tracking areas for regional provision of service list.

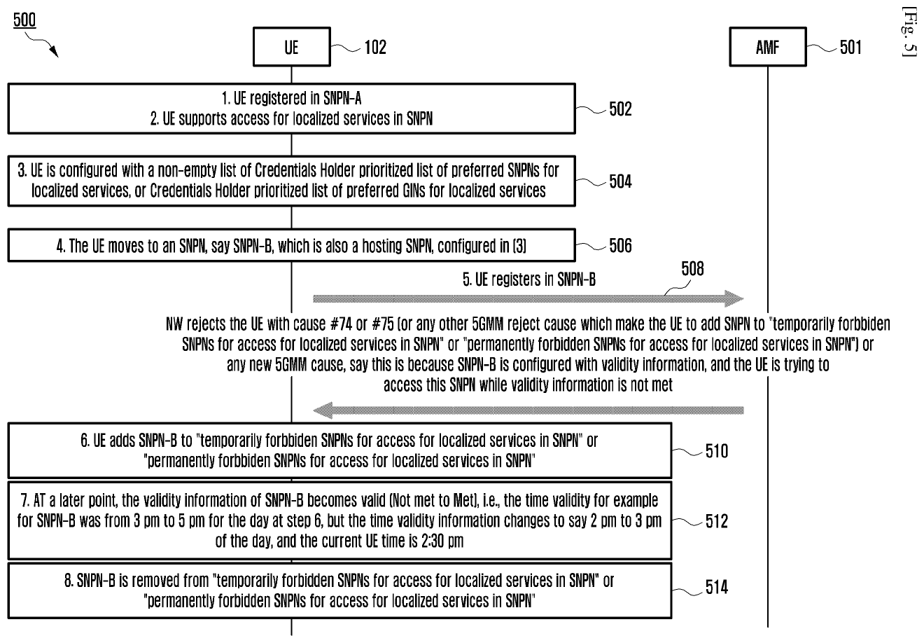

FIG. 4 shows a flowchart illustrating an example method for deleting forbidden SNPN from “permanently forbidden SNPNs for access for localized services in SNPN” or “temporarily forbidden SNPNs for access for localized services in SNPN” lists, in accordance with some embodiments of the present disclosure.

As illustrated in FIG. 4, the method 400 may comprise one or more steps.

The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

The method 400 may comprise, at step 402, receiving, by a UE 102, subscriber data associated with a home network (HN) to which the UE 102 is subscribed. The subscriber data comprises the forbidden SNPN list having time validity information corresponding to each forbidden SNPN present in the forbidden SNPN list. The subscriber data further comprises an indication regarding steering of roaming SNPN selection information for localized services in SNPN (SOR-SNPN-SI-LS). In one of the non-limiting embodiments of the present disclosure, the SOR-SNPN-SI-LS is received by the UE based on the indication.

At step 404, the method 400 may comprise performing an SNPN selection procedure on a plurality of SNPNs capable of being accessed by the UE for selecting at least one SNPN among the plurality of SNPNs.

At step 406, the method 400 may comprise receiving the SOR-SNPN-SI-LS based on the performing of the SNPN selection procedure.

At step 408, the method may further comprise determining, based on the SNPN selection procedure, that the UE 102 is unable to select the at least one SNPN for being present in the forbidden SNPN list. Based on the determination, at step 410, the method 400 may further comprise dynamically updating the forbidden SNPN list by removing an entry corresponding to the at least one SNPN from the forbidden SNPN list, to allow the UE to access the localized services of the at least one SNPN upon detecting the following conditions. The following conditions comprises determining when the time validity information of the at least one SNPN is prior to or matches with current time of the UE. In one of the non-limiting embodiments of the present disclosure, the time validity information comprises one or more time periods in which access to the corresponding SNPN for accessing corresponding localized services is allowed.

The second condition comprises determining when the time validity information of the least one SNPN changes from not meet condition to meet condition. The third condition comprises determining the expiry of a predetermined time-interval being tracked by a timer; and the fourth condition comprises determining when the at least one SNPN is received as part of the SOR-SNPN-SI-LS. In one of the non-limiting embodiments of the present disclosure, after removing the entry corresponding to the at least one SNPN from the forbidden SNPN list, the method 400 further comprising registering the at least one SNPN for allowing the UE to access the localized services in SNPN associated with the at least one SNPN.

In one of the non-limiting embodiments of the present disclosure, the forbidden SNPN list comprises at least one of: temporarily forbidden SNPNs for access for localized services in SNPN list or a permanently forbidden SNPNs for access for localized services in SNPN list.

In one of the non-limiting embodiments of the present disclosure, the method 400 may comprise updating the at least one of the temporarily forbidden SNPN list or the permanently forbidden SNPN list by adding an SNPN of the plurality of SNPNs when a registration request made by the UE to the SNPN is rejected by the SNPN due to one or more causes provided under 5G Mobility Management (5GMM).

In one of the non-limiting embodiments of the present disclosure, forbidden SNPN list further comprises an SNPN identity and a location validity information corresponding to each forbidden SNPN present in the forbidden SNPN list.

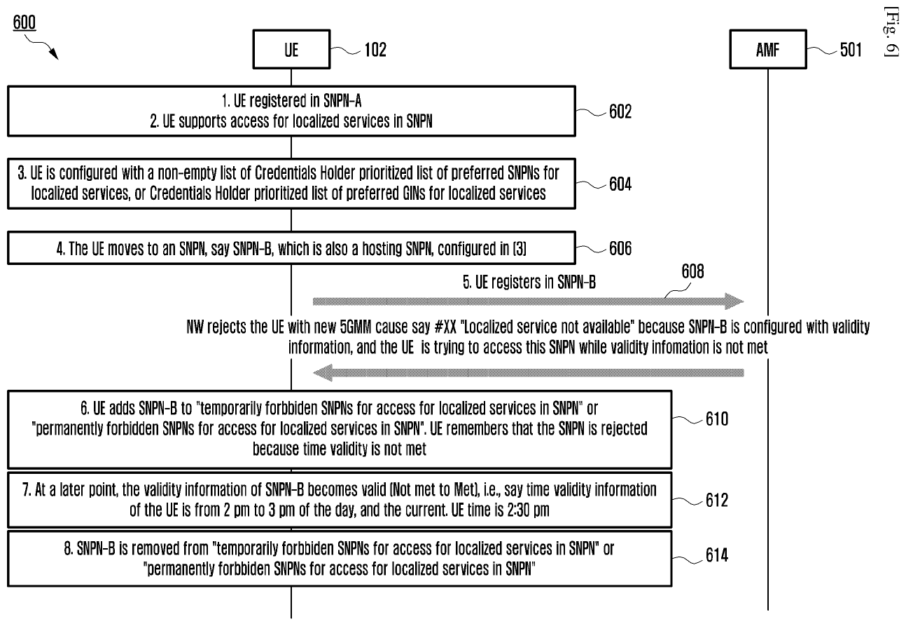

FIG. 5 shows a flow diagram illustrating a scenario, which shows the handling of forbidden SNPNs, on detecting a change in the validity information, according to embodiments as disclosed herein;

FIG. 5 particularly illustrates the techniques for deleting forbidden SNPN from “permanently forbidden SNPNs for access for localized services in SNPN” or “temporarily forbidden SNPNs for access for localized services in SNPN” lists on change of validity information of an SNPN configured in the “Credentials Holder (CH) controlled prioritized list of SNPNs for localized services in SNPN” or “Credentials Holder (CH) controlled prioritized list of SNPNs GINs for localized services in SNPN”, when the SNPN is forbidden as the home network rejects the UE with exemplary causes which make the UE to add SNPN to “temporarily forbidden SNPNs for access for localized services in SNPN” or “permanently forbidden SNPNs for access for localized services in SNPN”. For instance, one of the rejection causes may be that SNPN-B is configured with validity information, and the UE 102 is trying to access this SNPN while validity information is not met.

In scenario 500, considering that a UE 102 has a localized service subscription and the subscription is periodic in nature. Further at step 502, the UE 102 may be registered in SNPN-A and support access for localized services in SNPN. At step 504, the UE is configured with a non-empty list of Credentials Holder prioritized list of preferred SNPNs for localized services, or Credentials Holder prioritized list of preferred GINs for localized services. Considering the scenario at step 506, when the UE moves to another SNPN, i.e., SNPN-B. At step 508, the home network may reject the UE 102 with any rejection cause due to prevalent reasons. The rejection causes may be cause #74 or #75 or any other or new 5GMM reject cause which make the UE to add SNPN to “temporarily forbidden SNPNs for access for localized services in SNPN” or “permanently forbidden SNPNs for access for localized services in SNPN” This rejection triggers the UE 102 at step 510 to add SNPN-B to “temporarily forbidden SNPNs for access for localized services in SNPN” or “permanently forbidden SNPNs for access for localized services in SNPN”. In the present scenario, the prevalent reason may be that the SNPN-B is configured with validity information, and the UE is trying to access SNPN-B when validity information is not met. For example, if the SNPN was configured in the configured in the “CH controlled prioritized list of SNPNs for localized services in SNPN” or “CH controlled prioritized list of SNPNs GINs for localized services in SNPN” with validity information of 10 am to 11 am of the day. When the validity information of the SNPN expires, i.e., after 11 am of the day, the SNPN is deleted from the lists. The rejection due to various causes triggers the UE to add SNPN-B to “temporarily forbidden SNPNs for access for localized services in SNPN” or “permanently forbidden SNPNs for access for localized services in SNPN”. However, at a later point, at step 512 the validity information of SNPN-B may become valid. For instance, the time validity for SNPN-B was initially from 3 pm to 5 pm for the day but now the time validity information changes to say 2 pm to 3 pm of the day. Considering that the current UE time is 2:30 pm, the validity information of SNPN-B now has become valid. However, the existing techniques fail to address this scenario for SNPN-B, thereby rendering SNPN-B to incorrectly continue to stay in the “temporarily forbidden SNPNs for access for localized services in SNPN” or “permanently forbidden SNPNs for access for localized services in SNPN. This is disadvantageous to a UE that wishes to select SNPN-B for access to localized services, however, is unable to access due to the its entry in the forbidden list. The techniques of the present disclosure describes dynamically updating a forbidden standalone non-public network (SNPN) list for improved access to localized services by facilitating the UE at step 514 to remove SNPN-B from the list of “temporarily forbidden SNPNs for access for localized services in SNPN” or “permanently forbidden SNPNs for access for localized services in SNPN”, so that the UE is enabled to select SNPN-B as a hosting SNPN and thereby access the localized services of SNPN-B. Thus, the method of the present disclosure provides a technique of improved access to localized services, which was not possible in existing scenarios.

The UE, and an Access and Mobility Management Function (AMF) 501 together may perform the SNPN selection and registration procedures.

In another embodiment, if an SNPN was added to “temporarily forbidden SNPNs for access for localized services in SNPN” or “permanently forbidden SNPNs for access for localized services in SNPN” at 10 am of the day although the validity information is for 2 pm to 3 pm of the day. At 2 pm of the day, the UE should remove the SNPN from the forbidden SNPN lists.

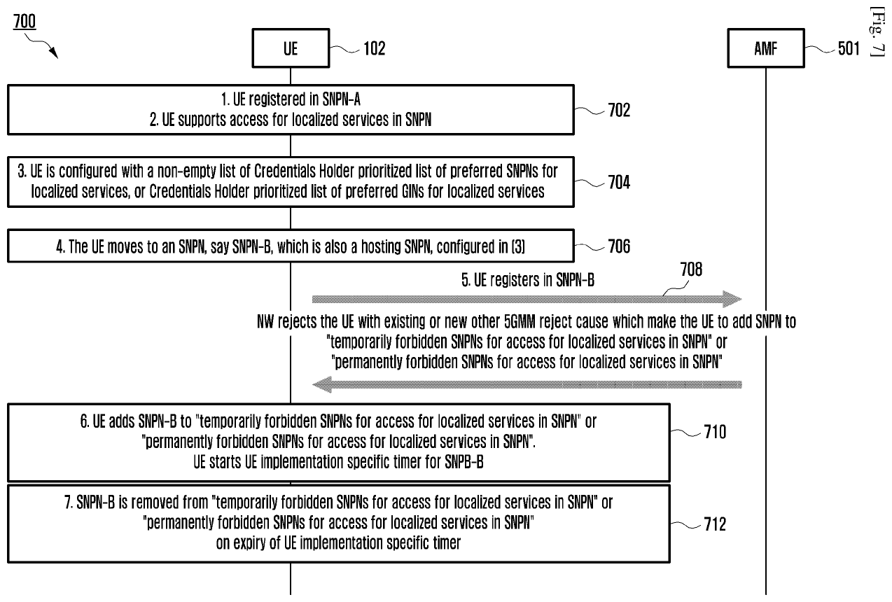

FIG. 6 shows a flow diagram illustrating a scenario 600, which shows the handling of forbidden SNPNs, on detecting a change in the validity information, where a new 5GMM cause is used by the home network to reject the UE when the UE accesses an SNPN, according to embodiments as disclosed herein. In FIG. 6 when the SNPN is forbidden due to rejection of the selected SNPN with new 5GMM cause say #XX “Localized service not available”, the UE adds SNPN to “temporarily forbidden SNPNs for access for localized services in SNPN” or “permanently forbidden SNPNs for access for localized services in SNPN) or any new 5GMM cause. steps 602 to 606 are similar to the steps of 502 to 506 of FIG. 5, where a UE registered to an SNPN, now moves to another SNPN.

According to an embodiment of the present disclosure, at step 608 A new 5GMM is introduced by the 3GPP, say #XX “Localized service not available” Is encountered, which make the UE to add SNPN to “temporarily forbidden SNPNs for access for localized services in SNPN” or “permanently forbidden SNPNs for access for localized services in SNPN. The techniques of the present disclosure are adaptable such that the UE at step 610 remembers or memorizes that SNPN is added in the list due to Localized service being not available currently. Later at step 612 when the validity information SNPN-B becomes valid, the UE 102 at step 614 shall remove memorized SNPN-B added to the either “temporarily forbidden SNPNs for access for localized services in SNPN” or “permanently forbidden SNPNs for access for localized services in SNPN” due to the condition of localized service not available previously. Or due to the condition of localized service was not available previously and for which validity information of SNPN has now changed from not met to be met.

In the present disclosure, the UE 102 may take into account the condition of time validity information of the SNPN changing from “previously not met” scenario to “currently being met” scenario” The UE may be enabled to delete the SNPN from the “Credentials Holder (CH) controlled prioritized list of SNPNs for localized services in SNPN” or “CH controlled prioritized list of SNPNs GINs for localized services in SNPN” and perform SNPN selection if required as per 3GPP TS 23.122.

In another embodiment, when UE tries to perform Non-Access Stratum (NAS) procedure and later gets rejected due to various causes, the UE shall delete the SNPN from the “CH controlled prioritized list of SNPNs for localized services in SNPN” or “CH controlled prioritized list of SNPNs GINs for localized services in SNPN” and perform SNPN selection as per 3GPP TS 23.122.

In one of the embodiments, the various causes by which UE adds SNPN to “temporarily forbidden SNPNs for access for localized services in SNPN” or “permanently forbidden SNPNs for access for localized services in SNPN are:

### Cause #12—Tracking Area Not Allowed

This 5GMM cause is sent to the UE if it requests service, or if the network initiates a de-registration request, in a tracking area where the HPLMN or SNPN determines that the UE, by subscription, is not allowed to operate.

If 5GMM cause #12 is sent to a roaming subscriber the subscriber is denied service even if other PLMNs are available on which registration was possible.

### Cause #13—Roaming Not Allowed in this Tracking Area

This 5GMM cause is sent to a UE which requests service, or if the network initiates a de-registration request, in a tracking area of a PLMN or SNPN which by subscription offers roaming to that UE but not in that tracking area.

This 5GMM cause can also be sent to the UE when the disaster condition is no longer being applicable in the current location of the UE.

### Cause #15—No Suitable Cells in Tracking Area

This 5GMM cause is sent to the UE if it requests service, or if the network initiates a de-registration request, in a tracking area where the UE, by subscription, is not allowed to operate, but when it should find another allowed tracking area in the same PLMN or an equivalent PLMN or the same SNPN or an equivalent SNPN.

### Cause #74—Temporarily Not Authorized for this SNPN

This 5GMM cause is sent to the UE if it requests access, or if the network initiates a de-registration procedure, in a cell belonging to an SNPN for which the UE has no subscription to operate or for which the UE is not allowed to operate onboarding services.

### Cause #75—Permanently Not Authorized for this SNPN

This 5GMM cause is sent to the UE if it requests access, or if the network initiates a de-registration procedure, in a cell belonging to an SNPN with a globally-unique SNPN identity for which the UE either has no subscription to operate, the UE's subscription has expired or the UE is not allowed to operate onboarding services.

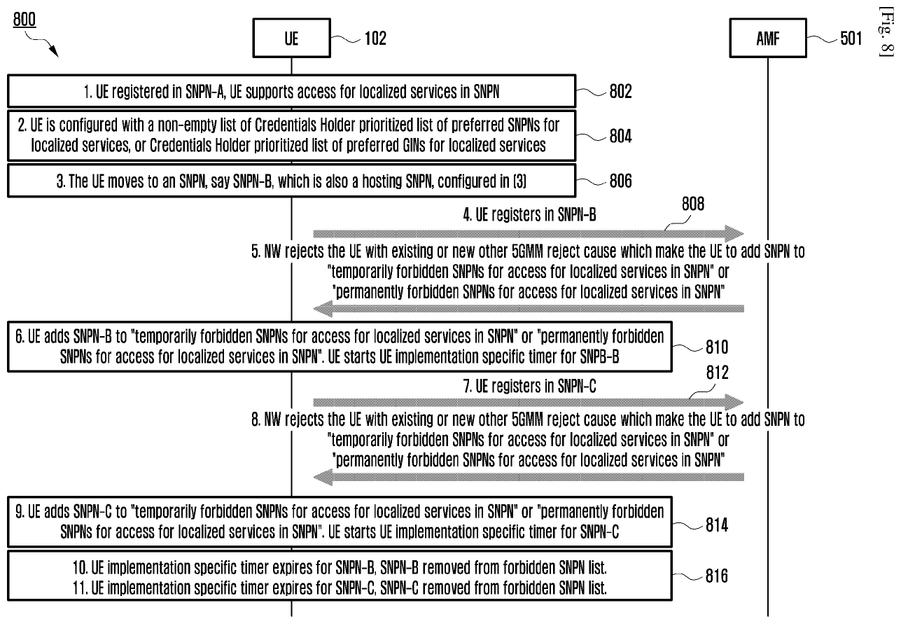

FIG. 7 shows a flow diagram illustrating a scenario 700, which shows the handling of forbidden SNPNs, on detecting a change in the validity information and when utilizing an implementation specific timer for a SNPN in the network, according to embodiments as disclosed herein. Steps 702 to 706 are similar to the steps of 502 to 506 of FIG. 5, where a UE registered to an SNPN, now moves to another SNPN.

In another embodiment, at step 708 the UE 102 shall remove an SNPN from the list of “temporarily forbidden SNPNs for access for localized services in SNPN” which is, if the UE 102 supports access to an SNPN using credentials from a credentials holder, associated with the selected entry of the “list of subscriber data” or the selected PLMN subscription, and supports access to an SNPN providing access for localized services in SNPN if the time validity information for the SNPN changes from ‘not met to met’ and the SNPN was part of the “temporarily forbidden SNPNs for access for localized services in SNPN” The UE 102 at step 710 may initiate an implementation specific timer or in an embodiment a T3245 timer. At step 712, the UE 102 shall remove an SNPN-B from the list of “permanently forbidden SNPNs for access for localized services in SNPN” which is, if the UE supports access to an SNPN using credentials from a credentials holder, associated with the selected entry of the “list of subscriber data” or the selected PLMN subscription, and supports access to an SNPN providing access for localized services in SNPN if the time validity information for the SNPN changes from ‘not being met’ to ‘being met’ and UE implementation specific timer or T3245 has expired.

On expiry of the UE implementation specific timer the UE shall delete the “permanently forbidden SNPNs for access for localized services in SNPN” list or “temporarily forbidden SNPNs for access for localized services in SNPN” or delete the SNPN from permanently forbidden SNPNs for access for localized services in SNPN” list or “temporarily forbidden SNPNs for access for localized services in SNPN”

In another embodiment, when the UE is rejected with existing 5GMM causes or some new 5GMM cause say #XX “Localized service not available”, which will be used by the home network to reject the UE when the UE accesses an SNPN for which the validity information has not been met, the UE shall add the SNPN to “temporarily forbidden SNPNs for access for localized services in SNPN” or “permanently forbidden SNPNs for access for localized services in SNPN”. Additionally, the UE shall start an existing 5GMM timer or new 5GMM timer, after the expiry of which the UE shall remove the SNPN from the forbidden SNPN lists or delete the above mentioned forbidden SNPN lists. Optionally, the UE shall maintain one such timer for every rejected SNPN.

In another embodiment, when the UE 102 is rejected with existing 5GMM causes or some new 5GMM cause say #XX “Localized service not available”, which will be used by the home network to reject the UE when the UE 102 accesses an SNPN for which the validity information is not met, the UE 102 shall add the SNPN to “temporarily forbidden SNPNs for access for localized services in SNPN” or “permanently forbidden SNPNs for access for localized services in SNPN”. Additionally, the UE 102 shall start existing 5GMM timer T3245. The UE 102 shall restart or re-adjust the timer value when further SNPNs are added to the above forbidden SNPN lists later or when the validity conditions of respective SNPN changes. Optionally, the minimum value of the timer after re-adjusting will be the time difference between the current UE time and start of time validity of the SNPN having the minimum validity start time. On expiry of timer T3245, all SNPNs are removed from the “temporarily forbidden SNPNs for access for localized services in SNPN” or “permanently forbidden SNPNs for access for localized services in SNPN”

In one embodiment, when two SNPNs: SNPN-1 and SNPN-2 are rejected with existing 5GMM causes or some new 5GMM cause say #XX “Localized service not available”, which will be used by the home network to reject the UE, when the UE accesses an SNPN for which the validity information has not been met, the UE shall add the SNPNs to “temporarily forbidden SNPNs for access for localized services in SNPN” or “permanently forbidden SNPNs for access for localized services in SNPN”. The UE shall start individual timers for both SNPN-1 and SNPN-2 and remove the SNPNs from the above mentioned forbidden SNPN lists when the corresponding timers expire.

In one embodiment, when SNPN-1 and SNPN-2 are rejected consecutively with existing 5GMM causes or some new 5GMM cause say #XX “Localized service not available”, which will be used by the home network to reject the UE when the UE accesses an SNPN for which the validity information is not met, the UE shall add the SNPNs to “temporarily forbidden SNPNs for access for localized services in SNPN” or “permanently forbidden SNPNs for access for localized services in SNPN”. Additionally, the UE shall start T3245 for SNPN-1 for say duration T. While adding SNPN-2 to the above forbidden lists, the UE shall re-start or re-adjust the timer value of T3245. The minimum timer value will be calculated as follows. Say, the current UE time is 2 pm, and the start time of validity information of the first SNPN is 3 pm, and the 2^{nd} SNPN is 4 pm, the timer will be started with at least 1 hour (3 pm-2 pm). On T3245 expiry, both SNPN-1 and SNPN-2 will be removed from the above forbidden SNPN lists.

In an embodiment, when the UE 102 adds an SNPN to the “permanently forbidden SNPNs for access for localized services in SNPN” list or “temporarily forbidden SNPNs for access for localized services in SNPN” list which are associated with the selected entry of the “list of subscriber data” or the selected PLMN subscription for 3GPP access or non-3GPP access, the UE is not configured for timer T3245 and the UE implementation specific timer is not running, the UE shall start timer UE implementation specific timer with a random value uniformly drawn from the range between the start time point and the end time point of the next valid time period for localized services in SNPN.

Additionally in another embodiment, the UE shall use the logic in the first and second examples (as disclosed above) to either run separate instances of UE implementation specific timer for every SNPN; or one instance of UE implementation specific timer, and restart or re-adjust the timer value when further SNPNs are added to the above forbidden SNPN lists later or when existing SNPN validity conditions are modified/changed/updated.

FIG. 8 shows a flow diagram illustrating another exemplary scenario 800, which shows the handling of forbidden SNPNs, on detecting a change in the validity information and when utilizing specific timers for a SNPN in the network, according to embodiments as disclosed herein. Steps 802 to 806 are similar to the steps of 502 to 506 of FIG. 5, where UE 102 registered to an SNPN, now moves to another SNPN. Scenario 800 shows the handling of forbidden SNPNs, on detecting a change in the validity information, wherein the UE 102 shall run one instance of UE implementation specific timer, and restart or re-adjust the timer value when further SNPNs are added to the above forbidden SNPN lists later or when existing SNPN validity conditions are modified/changed/updated.

In one of the embodiments, the UE 102 shall run separate instances of UE implementation specific timer for every SNPN. In step 802, the UE 102 may be registered in SNPN-A. The UE 102 may support access for localized services in SNPN. In step 804, the UE 102 may be configured with a non-empty list of Credentials Holder prioritized list of preferred SNPNs for localized services, or Credentials Holder prioritized list of preferred GINs for localized services. In step 806, the UE 102 may move to an SNPN, say SNPN-B, which is also a hosting SNPN, as configured in block. In step 808, the UE 102 may register in SNPN-B. The home network rejects the UE 102 with existing or new other 5GMM reject cause which make the UE 102 to add SNPN to “temporarily forbidden SNPNs for access for localized services in SNPN” or “permanently forbidden SNPNs for access for localized services in SNPN” In step 810, the UE 102 may add SNPN-B to “temporarily forbidden SNPNs for access for localized services in SNPN” or “permanently forbidden SNPNs for access for localized services in SNPN”. The UE 102 may start UE implementation specific timer.

In step 812, the UE 102 may move to an SNPN, say SNPN-C, which is also a hosting SNPN, and the home network rejects the UE 102 with existing or new other 5GMM reject cause which make the UE 102 to add SNPN to “temporarily forbidden SNPNs for access for localized services in SNPN” or “permanently forbidden SNPNs for access for localized services in SNPN”. In step 814, the UE 102 may add SNPN-C to “temporarily forbidden SNPNs for access for localized services in SNPN” or “permanently forbidden SNPNs for access for localized services in SNPN”. The UE may start UE implementation specific timer for SNPN-C. In step 816, on the expiry of UE implementation specific timer for SNPN-B, SNPN-B may be removed from the forbidden SNPN list and on the expiry of UE implementation specific timer expiring for SNPN-C, SNPN-C is removed from the forbidden SNPN list.

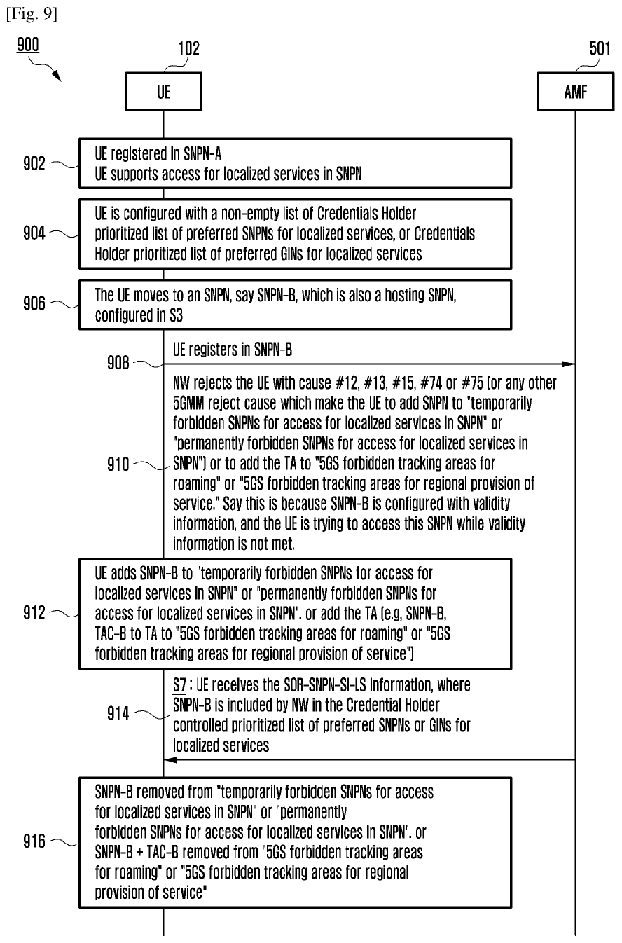

FIG. 9 shows a flow diagram illustrating a scenario, handling the deletion of forbidden SNPN from “forbidden tracking areas for roaming” or “5GS forbidden tracking areas for regional provision of service”, accordingly to embodiments as disclosed herein.

In one of the embodiments of the present disclosure, the techniques of the present disclosure describes the scenario when considering steering of roaming SNPN selection information for localized services in SNPN (SOR-SNPN-SI-LS) received by the UE 102. The embodiments here below provides techniques to delete or remove forbidden SNPN from forbidden SNPN for localized services on receiving SOR-SNPN-SI-LS. The SOR-SNPN-SI-LS provisions information for SNPN selection (if the access for localized services in SNPN has been enabled) by UE 102 supporting access to an SNPN providing access for localized services in SNPN. The information comprises (a) a “credentials holder controlled prioritized list of preferred SNPNs for access for localized services in SNPN”, where each entry contains an SNPN identity and a validity information consisting of time validity information or optionally, location assistance information; b) a “credentials holder controlled prioritized list of preferred GINs for access for localized services in SNPN”, where each entry contains a GIN and a validity information consisting of time validity information or optionally, location assistance information; or c) both of the above. In one of the embodiments, the SOR-SNPN-SI-LS list can be extended to SOR-SNPN-SI list as well.

In an embodiment, on receiving the SOR-SNPN-SI-LS, the UE 102 may replace the “credentials holder controlled prioritized list of preferred SNPNs for access for localized services in SNPN” for the selected entry of the “list of subscriber data” or the selected PLMN subscription with the received “credentials holder controlled prioritized list of preferred SNPNs for access for localized services in SNPN”, if any. The UE 102 may replace the “credentials holder controlled prioritized list of preferred GINs for access for localized services in SNPN” for the selected entry of the “list of subscriber data” or the selected PLMN subscription with the received “credentials holder controlled prioritized list of preferred GINs for access for localized services in SNPN”, if any. The UE 102 may delete the SNPNs identified by the “credentials holder controlled prioritized list of preferred SNPNs for access for localized services in SNPN” from the list of “temporarily forbidden SNPNs for access for localized services in SNPN” and the list of “permanently forbidden SNPNs for access for localized services in SNPN” if they are present in these lists.

For example, when an SNPN-A was added in the forbidden SNPN lists and later the UE receives the SNPN-A as part of the SoR-SNPN-SI-LS information, the UE removes the SNPN-A from the forbidden SNPN lists and perform SNPN selection in the SNPN-A if required.

The above embodiment is also extended for equivalent SNPNs as well, which are also hosting SNPNs. For example, when the SNPN-A and SNPN-B were added in the forbidden SNPN lists, where SNPN-B is equivalent SNPN of SNPN-A, later UE receives SNPN-A as part of the SoR-SNPN-SI-LS information, the UE removes SNPN-A and SNPN-B both from the forbidden SNPN lists and perform SNPN selection in SNPN-A/SNPN-B if required.

In an embodiment, when the SoR-SNPN-SI-LS is received and the security check is successful, then: the UE 102 deletes the TAs in the “5GS forbidden tracking areas for roaming” or “5GS forbidden tracking areas for regional provision of service” for the selected entry of the “list of subscriber data” or the selected PLMN subscription, identified by the “credentials holder controlled prioritized list of preferred SNPNs for access for localized services in SNPN” from the list of “temporarily forbidden SNPNs for access for localized services in SNPN” and the list of “permanently forbidden SNPNs for access for localized services in SNPN”, when they are present in these lists. The proposal can be extended to “temporarily forbidden SNPNs” and the list of “permanently forbidden SNPNs” lists as well. The forbidden lists in this solution can be extended to forbidden lists for PLMNs as well in this embodiment.

For example, when SNPN-A+TAC-A was added “5GS forbidden tracking areas for roaming” or “5GS forbidden tracking areas for regional provision of service”, later UE 102 receives SNPN-A as part of the SoR-SNPN-SI-LS or SOR-SNPN-SI information, UE 102 removes SNPN-A +TAC-A from the “5GS forbidden tracking areas for roaming” or “5GS forbidden tracking areas for regional provision of service” and perform SNPN selection in SNPN-A if required. The UE 102 deletes the SNPNs identified by the “credentials holder controlled prioritized list of preferred SNPNs for access for localized services in SNPN” from the list of “temporarily forbidden SNPNs for access for localized services in SNPN” and the list of “permanently forbidden SNPNs for access for localized services in SNPN”, if they are present in these lists, for the selected entry of the “list of subscriber data” or the selected PLMN subscription.

The above mentioned embodiment is also applicable for hosting SNPNs or equivalent hosting SNPNs, or TAs corresponding to such SNPNs. The forbidden SNPN lists and the forbidden TA lists mentioned in this embodiment can be extended to any other existing forbidden SNPN or TA lists. The SOR-SNPN-SI-LS list ca be extended to SOR-SNPN-SI list as well in this embodiment.

As shown in the FIG. 9, at step 902, the UE 102 may be registered in SNPN-At step 902, the UE 102 may support access for localized services in the SNPN.

At step 904, the UE 102 may be configured with a non-empty list of Credentials Holder prioritized list of preferred SNPNs for localized services, or Credentials Holder prioritized list of preferred GINs for localized services.

At step 906, the UE 102 may move to an SNPN, say SNPN-B, which is also a hosting SNPN.

At step 908, the UE 102 may register in SNPN-B. At step 910, the home network may reject the UE 102 with cause #12, #13, #15, #74 or #75 (or any other 5GMM reject cause which make the U to add SNPN to “temporarily forbidden SNPNs for access for localized services in SNPN” or “ permanently forbidden SNPNs for access for localized services. in SNPN ”) or to add the TA to “5GS forbidden tracking areas for roaming” or “5GS forbidden tracking areas for regional provision of service”. Say this is because the SNPN-B is configured with validity information, and the UE-102 is trying to access this SNPN while validity information is not met.

At step 912, the UE 102 may add the SNPN-B to “temporarily forbidden SNPNs for access for localized services in the SNPN” or “permanently forbidden SNPNs for access for localized services in the SNPN” or add the TA (e.g. SNPN-B, TAC-B to TA to “5GS forbidden tracking areas for roaming” or “5GS forbidden tracking areas for regional provision of service”). At step 914, the UE 102 may receive the SOR-SNPN-SI-LS, where SNPN-B may be included by home network in the Credentials Holder controlled prioritized list of preferred SNPNs or GINs for localized services. At step 916, the UE 102 will remove from “temporarily forbidden SNPNs for access for localized services in SNPN” or “permanently 15 forbidden SNPNs for access for localized services in SNPN”, or SNPN-B +TAC-B will be removed from “5GS forbidden tracking areas for roaming” or “5GS forbidden tracking areas for regional provision of service”.

In light of the technical advancements provided by the proposed method and the system the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The above methods 300 and 400 may be described in the general context of computer-executable instructions. Generally, computer-executable instructions can include routines, programs, objects, components, data structures, procedures, modules, and functions, which perform specific functions or implement specific abstract data types.

The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s) shown in FIGS. 1-7. Generally, where there are operations illustrated in Figures, those operations may have corresponding counterpart means-plus-function components.

It may be noted here that the subject matter of some or all embodiments described with reference to FIGS. 1-9 may be relevant for the methods and the same is not repeated for the sake of brevity.

In a non-limiting embodiment of the present disclosure, one or more non-transitory computer-readable media may be utilized for implementing the embodiments consistent with the present disclosure. Certain aspects may comprise a computer program product for performing the operations presented herein. For example, such a computer program product may comprise a computer-readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

1. A method performed by a terminal in a wireless communication system, the method comprising:
identifying whether the terminal supports access to a standalone non-public network (SNPN) providing access for a localized service in the SNPN;
identifying whether a preconfigured condition is satisfied, in case that the terminal supports access to the SNPN providing access for the localized service in the SNPN; and
removing the SNPN from a list associated with at least one forbidden SNPN, in case that the preconfigured condition is satisfied.

2. The method of claim 1, wherein the terminal is configured with a list of a subscriber data, and
wherein the SNPN is removed from the list associated with the at least one forbidden SNPN associated with the list of the subscriber data.

3. The method of claim 1, wherein the SNPN is removed from the list associated with the at least one forbidden SNPN associated with a selected public land mobile network (PLMN) subscription.

4. The method of claim 1, wherein the SNPN is removed from a list of temporarily forbidden SNPNs for access for localized services in the SNPN.

5. The method of claim 1, wherein the SNPN is removed from a list of permanently forbidden SNPNs for access for localized services in the SNPN.

6. The method of claim 1, wherein the preconfigured condition is satisfied in case that validity information of the SNPN changes from not met to met.

7. A terminal in a wireless communication system, the terminal comprising:
at least one processor configured to:
identify whether the terminal supports access to a standalone non-public network (SNPN) providing access for a localized service in the SNPN,
identify whether a preconfigured condition is satisfied, in case that the terminal supports access to the SNPN providing access for the localized service in the SNPN, and
remove the SNPN from a list associated with at least one forbidden SNPN, in case that the preconfigured condition is satisfied.

8. The terminal of claim 7, wherein the terminal is configured with a list of a subscriber data, and
wherein the SNPN is removed from the list associated with the at least one forbidden SNPN associated with the list of the subscriber data.

9. The terminal of claim 7, wherein the SNPN is removed from the list associated with the at least one forbidden SNPN associated with a selected public land mobile network (PLMN) subscription.

10. The terminal of claim 7, wherein the SNPN is removed from a list of temporarily forbidden SNPNs for access for localized services in the SNPN.

11. The terminal of claim 7, wherein the SNPN is removed from a list of permanently forbidden SNPNs for access for localized services in the SNPN.

12. The terminal of claim 7, wherein the preconfigured condition is satisfied in case that validity information of the SNPN changes from not met to met.
